(19) United States
(12) Patent Application Publication
(10) Pub. No.: US 2024/0304217 A1
(43) Pub. Date: Sep. 12, 2024

(54) PRODUCTION PALLET CONTROL SYSTEM AND PRODUCTION PALLET CONTROL METHOD

(71) Applicants: Kabushiki Kaisha Toshiba, Tokyo (JP); Toshiba Electronic Devices & Storage Corporation, Tokyo (JP)

(72) Inventor: Satoshi SHIBATA, Fussa Tokyo (JP)

(21) Appl. No.: 18/367,716

(22) Filed: Sep. 13, 2023

(30) Foreign Application Priority Data
Mar. 10, 2023 (JP) 2023-037803

(51) Int. Cl. G11B 7/24097; G11B 5/55; G11B 23/00

(52) U.S. Cl. CPC G11B 7/24097; G11B 5/556; G11B 23/0042; G11B 21/083

(57) ABSTRACT

According to one embodiment, a production pallet control system comprises a plurality of magnetic disk devices configured to execute a plurality of processes, and the magnetic disk devices configured to output status information related to the process based on a requires from the outside and a controller connected to the magnetic disk devices in a mutually communicable manner, the controller configured to inquire the status information of each of the magnetic disk devices.

### CROSS-REFERENCE TO RELATED APPLICATIONS

This application is based upon and claims the benefit of priority from Japanese Patent Application No. 2023-037803, filed Mar. 10, 2023, the entire contents of which are incorporated herein by reference.

### FIELD

Embodiments described herein relate generally to a production pallet control system which controls a manufacturing process of a magnetic disk device, and a production pallet control method of the same.

### BACKGROUND

The manufacturing process of magnetic disk devices (HDDs) includes a plurality of processes. Some of the processes are easily influenced by external oscillation, and some tend to oscillate other processes.

For example, a blank disk self servo write (BDSSW) pattern write, which is one of the manufacturing processes, includes some processes which are easily influenced by external oscillation, and some which tend to oscillate other processes, and if such processes are executed untimely, there may be an increase of failed products and degraded quality in the manufacturing process.

The present embodiment will present a production pallet control system which controls a manufacturing process of a magnetic disk device, and a production pallet control method of the same.

### BRIEF DESCRIPTION OF THE DRAWINGS

FIG. 1 illustrates an example of a system structure of a manufacturing process of a magnetic disk device of an embodiment.

FIG. 2 is a functional block diagram illustrating a magnetic disk device of the embodiment.

FIG. 3 is a functional block diagram illustrating a controller PC of the embodiment.

FIG. 4 illustrates an example of a message exchanged between the magnetic disk device and the controller PC of the embodiment.

FIG. 5 illustrates an example of a database indicative of policies used to determine the control process of the magnetic disk device by the controller PC of the embodiment.

FIG. 6 illustrates an example of operation schedule of the magnetic disk device by the controller PC of the embodiment.

FIG. 7 is a flowchart of a test treatment of HDD by the controller PC of the embodiment.

FIG. 8 is a flowchart indicative of an operation schedule adjustment treatment of HDD by the controller PC of the embodiment.

FIG. 9 is a second flowchart indicative of an operation schedule adjustment treatment of HDD by the controller PC of the embodiment.

FIG. 10 illustrates an example of a database indicative of a relationship between the operation schedule adjustment condition of HDD of the controller PC and the adjustment treatment of the embodiment.

### DETAILED DESCRIPTION

Hereinafter, embodiments of the present application will be explained with reference to the accompanying drawings.

In general, according to one embodiment, a production pallet control system comprises a plurality of magnetic disk devices configured to execute a plurality of processes, and the magnetic disk devices configured to output status information related to the process based on a requires from the outside and a controller connected to the magnetic disk devices in a mutually communicable manner, the controller configured to inquire the status information of each of the magnetic disk devices.

### First Embodiment

In the present embodiment, an example where a controller PC side grasps all HDD operation modes in a pallet and requests an operation schedule change to a part of or all HDDs will be explained.

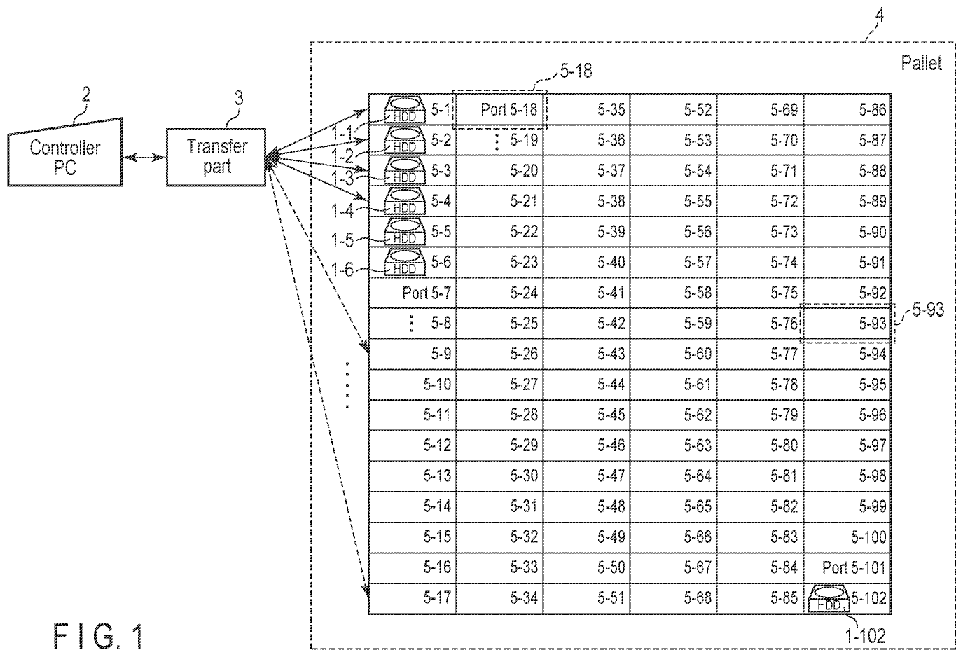

FIG. 1 is an example of a system structure of a manufacturing process of a magnetic disk device of the present embodiment, and specifically, is an example of the structure of a production pallet of a blank disk self servo write (BDSSW) which is one of the manufacturing processes.

The system of the present embodiment includes a controller PC 2 and each HDD 1 disposed in a plurality of ports 5 in a pallet 4, which are mutually communicable via a transfer part 3.

The magnetic disk device 1 (may be referred to as HDD 1) is a storage device with a magnetic disk which can read/write data therefrom/therein (hereinafter, may be referred to as disk), and includes a computer such as a microprocessor. The magnetic disk device 1 controls various internal functions and outputs data such as a message to the controller PC 2 based on, for example, a message received from the controller PC 2.

The controller PC 2 is, for example, a personal computer main body, and outputs a request such as data read/write command to the magnetic disk device 1. Furthermore, the controller PC 2 may include a program for testing the magnetic disk device 1, or may load a program to the magnetic disk device 1 or may activate a program by outputting a trigger signal and the like.

The transfer part 3 is, for example, a universal asynchronous receiver/transmitter (UART), which is a circuit to achieve mutual communication between the controller PC 2 and the HDD 1. In the present embodiment, the transfer part 3 is connected with the controller PC 2 via a serial cable, is connected with the HDD 1 via a serial cable or a parallel cable, has a function of serial-parallel conversion or parallel-serial conversion, and is mutually communicable with a plurality of HDDs 1 through a single controller PC 2.

The pallet 4 is a stage to which a large number of HDDs 1 can be attached, and is disposed in, for example, a temperature chamber. In the pallet 4, a lattice-shaped area (or may be referred to as ports) will be set as in the figure, where a port which is connectable with a cable is disposed in each area, and HDD 1 in each area is connected to a port via a cable, or the like, and thus is communicable with the controller PC 2 via UART 3. In each area, an HDD 1 and a port 5 correspond with each other one-by-one, and an HDD 1 disposed in an area will be referred to as, for example, HDD 1-N using a port number N (N is a natural integer) to which the HDD 1 is connected. Furthermore, similarly, an area and a port 5 correspond with each other one-by-one, and if a port number N=18, will be referred to as port 5-18. Furthermore, since a port 5 and an HDD 1 correspond with each other one-by-one, an HDD 1-N may be referred to as port 5-N. FIG. 1 illustrates an example where the pallet 4 includes 102 HDDs 1 and 102 ports 5, and if a specific distinction is unnecessary, they will be referred to as the HDD 1 and the port 5, respectively. Furthermore, the present embodiment is applicable to a case where a rack including multiple pallets 4 with the HDDs 1 is used to execute the manufacturing process of the HDD 1 per rack.

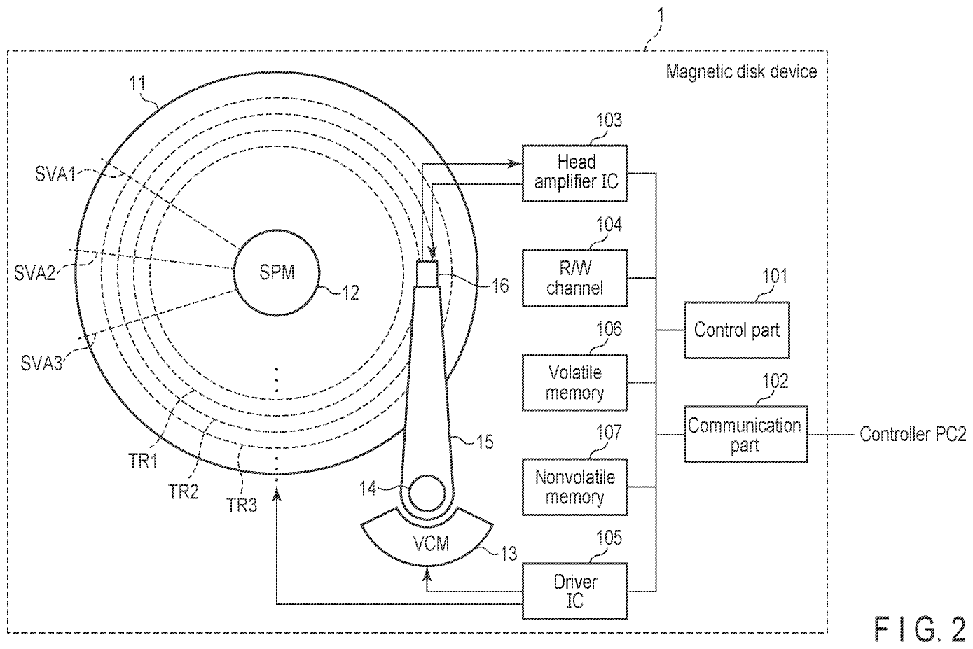

FIG. 2 is a functional block diagram of the magnetic disk device of the embodiment.

The disk 11 is a disk-shaped magnetic rotatable disk storage medium including a data writable (may be referred to data write) area in which a user data area which can be used by a user and a system area in which information required for the system management are assigned. Hereinafter, a direction orthogonal to a radial direction of the disk 11 will be referred to as circumferential direction. The disk 11 is attached to a spindle motor 12 and is rotated by the drive of the spindle motor 12.

A plurality of tracks are set in the disk 11. In the figure, three tracks TR1, TR2, and TR3 (or may be referred to as track TR if specific distinction is unnecessary) are shown for example while a plurality of tracks are set in a concentric manner about the spindle 12 in the data area. When executing read/write of data from/to the disk 11, a head 16 is moved to a track TR with write/read target data through a seek control, tracking control, and the like, and the head 16 performs the read/write.

Furthermore, servo information is written to the disk 11, which is used for a positional detection of the head 16, for example. The servo information is located in a position predetermined in the circumferential direction of the disk 11 (will be referred to as servo area). The servo information is a conventional technique, and thus, the detailed description thereof will be omitted. In the example of FIG. 1, three servo areas SVA1, SVA2, and SVA3 (or may be referred to as servo area SVA if specific distinction is unnecessary) are shown as an example of the servo area, however, generally, servo areas SVA are arranged in the entirety of the circumferential direction of the disk 11 at regular intervals, and the servo information is written in the servo area SVA in each track TR. A manufacturing process of writing the servo information to the disk 11 is the BDSSW pattern write.

The spindle 12 is a pillar of the disk 11, and is provided with, for example, the body of the magnetic disk device 1. When the spindle 12 rotates, the disk 11 rotates accordingly.

A VCM 13 is a voice coil motor type actuator, and is used to move the arm 15, or the like. The VCM 13 controls an operation of the arm 15 based on current or a voltage input thereto. Note that, in the present embodiment, the VCM 13 is used as an example, however, it is not limited to a voice coil motor type actuator.

A pivot 14 supports the arm 15, and the like, and is a bearing for rotation motion, for example.

The arm 15 is an arm supporting a head 16, transfers motion from the VCM 13 to the head 16, and moves the head 16 to a target track TR.

The head 16 is a portion to write data to the disk 11 and to read data recorded in the data tracks of the disk 11. Specifically speaking, the head to write data to the disk 11 will be referred to as write head 16W and the head to read data recorded in the data tracks of the disk 11 will be referred to as read head 16R.

A control part 101 is a hard disk controller which receives a message such as a command from the controller PC 2 and controls each component of the magnetic disk device 1 based on the received message. The control part 101 may contain a computer such as CPU or microprocessor, a hardware such as IC chip and the like with a computer, or a software. The control part 101 receives messages from the controller PC 2, for example, such as a data write command to the disk 11 and a data read command to the disk 11.

Specifically, upon receipt of a command for requesting status information from the controller PC 2, the control part 101 outputs the status information including an operation content of a currently-executed process, estimated time until the end of the process, process to be executed next, and the like, to the controller PC 2. The status information may be various information pieces related to operation conditions of the magnetic disk device 1 indicative of, for example, contents and execution conditions of the treatment currently-executed by the magnetic disk device 1, and to physical conditions of the magnetic disk device 1 indicative of, for example, internal temperature, power source voltage, power source capacity, in-pallet position of the magnetic disk device 1, wherein the magnetic disk device 1 may prepare status information thereof to be stored in, for example, a nonvolatile memory 107. The operation mode of the magnetic disk device 1 indicates a condition of the device including at least one of the operation condition and the physical condition.

Various treatments of the control part 101 may be executed by a software (including firmware, and the like) program, or may be executed by a hardware, or a combination of software and hardware.

A communication part 102 is connected to the port 5 via a cable, and exchanges data together with the controller PC 2 via the transfer part 3.

The head amplifier IC 103 includes, for example, a read amplifier and a write driver. The read amplifier amplifies a read signal read from the disk 11 to be output to an R/W channel 104. The write driver outputs write current corresponding to a signal output from the R/W channel 104 to the head 16.

The R/W channel 104 controls, in response to an instruction from the control part 101 and the like, the head amplifier IC 103 to perform data read from the disk 11 and data write to the disk 11. The R/W channel 104 receives a read data signal from the head amplifier IC 103 to extract data of the disk 11 (may be referred to as read data), and generates write data signal based on data commanded to be written (may be referred to as write data) to be output to the head amplifier IC 103. Furthermore, the R/W channel 104 may extract servo information from the read data signal received from the head amplifier IC 103.

The driver IC 105 outputs current or a voltage to drive and/or control the SPM 12 and the VCM 13 according to the control from the control part 101.

A volatile memory 106 is a semiconductor memory which loses data stored therein if power supply thereto is cut, and may be used as a working memory of the control part 101, for example. The volatile memory 106 is, for example, Dynamic Random Access Memory (DRAM) or Synchronous Dynamic Radom Access Memory (SDRAM).

The nonvolatile memory 107 is a semiconductor memory to hold data stored therein even if power supply thereto is cut. The nonvolatile memory 107 stores, for example, data and programs required for the treatments in the magnetic disk device 1 such as BDSSW program. The nonvolatile memory 107 is, for example, NOR or NAND flash ROM (Flash Read Only Memory: FROM).

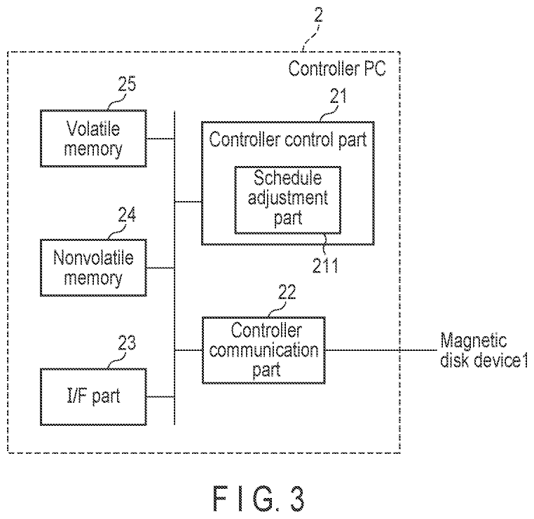

FIG. 3 is a functional block diagram of the controller PC of the embodiment.

The controller PC 2 is a terminal such as personal computer or smartphone including a computer with various communication interfaces, CPU, and memory. Note that, the controller PC 2 indicates a terminal connected to the disk device 1 in the manufacturing process, which is distinguished from a normal host terminal connected thereto after the manufacturing process (when being used, for example); however, such a normal host terminal may have a function of the controller PC 2.

The controller control part 21 receives various commands from an I/F part 23 to control each function of the controller PC 2 based on the received commands. The controller control part 21 may be a hardware such as microprocessor, or software, or a combination thereof.

The controller control part 21 executes a manufacturing process program or the like to load a program to the HDD 1, and to activate the loaded program. Furthermore, the controller control part 21 transmits a message to the magnetic disk device 1 and analyzes the message received from the magnetic disk device 1.

A schedule adjustment part 211 adjusts schedule for the execution and halt of processes in the manufacturing process of each HDD 1, and outputs a message to each HDD 1 based on the determined schedule.

A controller communication part 22 is connected to the transfer part 3 via a cable, and exchanges data with the HDD 1 via the transfer part 3.

The I/F part 23 is connected with peripheral devices such as mouse and keyboard, receives data input from the peripheral devices, and outputs the data to the controller control part 21 and the like.

A nonvolatile memory 24 is a semiconductor memory to hold data stored therein even if power supply thereto is cut. The nonvolatile memory 107 stores, for example, manufacturing process programs and data received from the magnetic disk device 1. The nonvolatile memory 24 is, for example, NOR or NAND Flash Read Only Memory (FROM).

A volatile memory 25 is a semiconductor memory which loses data stored therein if power supply thereto is cut, and may be a working memory of the controller control part 21 and the like. The volatile memory 25 is a Dynamic Random Access Memory (DRAM), or a Synchronous Dynamic Random Access Memory (SDRAM).

In the BDSSW which is a manufacturing process of the HDD 1, normally, a BDSSW program is loaded onto each HDD 1 from the controller PC 2, and once the BDSSW program is started, each HDD 1 individually operates to perform multiple processes included in the BDSSW. This may be referred to as autonomous method. In the autonomous method, the controller PC 2 waits for the end of BDSSW while acknowledging the current operation mode (process) of the HDD 1 in each port 5. In that case, the controller PC 2 does not perform communication with the port 5 and the HDD 1 of the port 5 autonomously performs predetermined operations.

In the pallet 4, a large number of HDDs 1 are operated, and relatively great oscillation is generated in processes such as load/unload operation of the head 16 of the HDD 1, emergency unload test, spindle motor activation, and if such processes are executed in multiple HDDs 1 at the same time, the oscillation energy therefrom may affect other HDDs 1 as external force. Especially, influence by the external force tends to be great when an initial pattern write (CGS write) time performed during the BDSSW execution. In the autonomous method, each HDD 1 simply performs predetermined operations, and thus, when the oscillation is generated and when the initial pattern write is executed depend on varied operation times of the HDDs 1, that is, depend on course of events in reality. The present embodiment is established based on such a background, and a manufacturing process prepared in consideration of the influence of the external force will be presented.

Similarly, when multiple HDDs 1 perform specific operations at the same time, the external force such as a temperature increase by heat generation, and a power source voltage decrease by a consumption power use increase may affect other HDDs 1, and such a case will be described later.

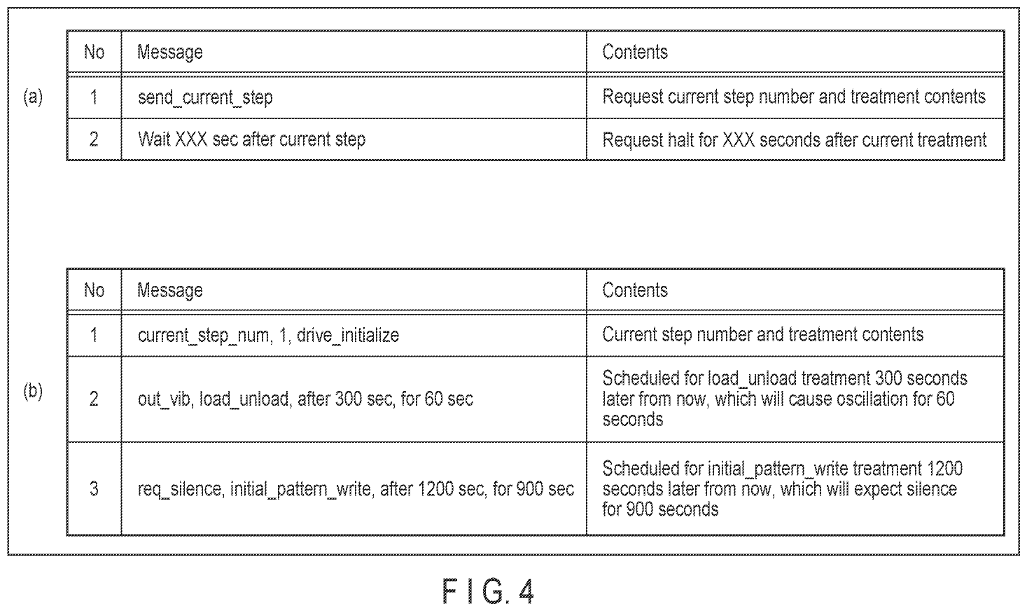

FIG. 4 illustrates an example of messages exchanged between the magnetic disk device and the controller PC of the embodiment.

FIG. 4(a) indicates a message issued by the controller PC 2 to the HDD 1, and each line indicates a message and contents of the message.

FIG. 4(b) indicates a reply message by the HDD 1 to the message issued by the controller PC 2, and each line indicates a message and contents of the message.

For example, upon receipt of a step number request message issued by the controller PC 2 (for example, No. 1 of FIG. 4(a)), the HDD 1 transmits a step number of treatment operation currently executed thereby and contents of the process to the controller PC 2 as a reply message (for example, No. 1 of FIG. 4 (b)).

For example, upon receipt of an operation halt request message issued by the controller PC 2 (for example, No. 2 of FIG. 4(a)), the HDD 1 halts the treatment operation currently executed thereby, and halts the process by a designated time based on a time count by, for example, the control part 101.

The message of No. 2 of FIG. 4(b) indicates that a lapse time of the process currently executed by the HDD 1 is counted, and a start time of the next process (load_unload treatment) is estimated, and a message containing an estimated start time (300 seconds) is sent to the controller PC 2. Upon receipt of the message, the controller PC 2 may control execution of the process of the HDD 1 on the pallet 4 if need be. The load_unload treatment is an example of the processes which tend to cause oscillation.

The message of No. 3 of FIG. 4(b) indicates that a lapse time of the process currently executed by the HDD 1 is counted, and a start time of the next process (initial_pattern_write treatment) is estimated, and a message containing an estimated start time (1200 seconds) is sent to the controller PC 2. Upon receipt of the message the controller PC 2 may control execution of the process of the HDD 1 on the pallet 4 if need be. The initial_pattetn_write treatment is an example of the processes which tend to be influenced by oscillation, and supplemental information of req_silence may be sent to the controller PC 2 to notify that the process tends to be influenced by oscillation. With the message of No. 3 of FIG. 4(b), the HDD 1 can request halt of operation of other HDDs 1 to the controller PC 2 when scheduled operation of the HDD 1 is executed.

That is, the HDD 1 estimates and reports an immediately close step from currently-executed operation step. For example, the HDD 1 may preliminarily hold a fixed table of average execution time of each operation step, measure a period of time between a start of the step and a current time, and estimate an end time of the currently-executed step and start times of the next and subsequent steps using the measured value.

On the other hand, the controller PC 2 side arbitrarily executes a message request to all of the HDDs 1 in the pallet 4 to grasp the operation mode of all of the ports 5 by performing the message request (may be an operation condition such as step number of the process).

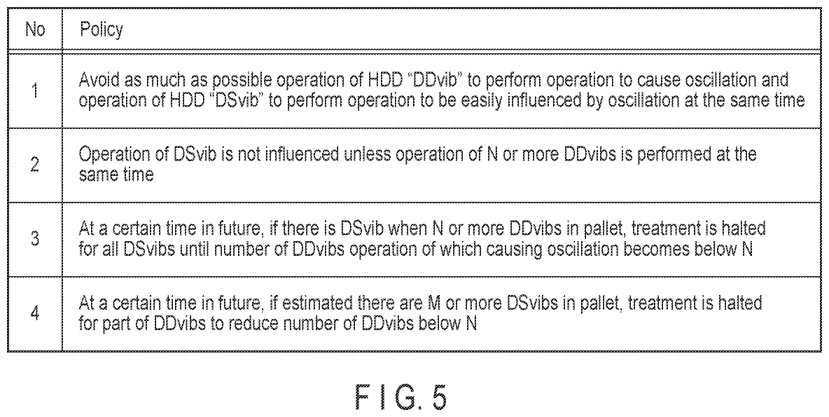

FIG. 5 illustrates an example of a policy used when the controller PC determines a control process of the magnetic disk device.

In this example, Drive Disturbance Vibration (DDvib) indicates an HDD 1 to execute an operation to generate oscillation, and Drive Sensitive Vibration (DSvib) indicates an HDD 1 to execute an operation to be easily influenced by oscillation. That is, DDvib indicates an HDD 1 to execute a process which influences other magnetic disk devices, and DSvib indicates an HDD 1 to execute a process which is influenced by other magnetic disk devices. Each policy is a condition to determine an operation of the DSvib or DDvib in accordance with the operation condition of DSvib or DDvib.

Specifically, for example, one or more policies shown in FIG. 5 may be reflected upon a program, and the controller PC 2 may generate a massage shown in FIG. 4 by the program and output the message to the corresponding HDD 1. Upon receipt of the message, the HDD 1 executes the treatment operation based on the policies from the program loaded.

Based on policy No. 1, for example, if it is set that DSvib does not exist when DDvib exists or in an expected time when DDvib is to exist, the controller PC 2 detects a time when DDvib is to operate and halts the operation of the DSvib which is to operate in the time.

Based on policy No. 2, for example, if it is set that operation of DSvib is performed in a time when the number of DDvibs become smallest, the controller PC 2 counts the number of DDvibs in a time when DDvibs are to operate, and if the number is less than N, let the DSvib which is expected to operate in the time operate (that is, halts control with respect to the DSvib).

Based on policy No. 3, for example, if the number of DDvibs in a certain time becomes N or more, the controller PC 2 halts the operation of the DSvib, and resumes the operation of the halted DSvib when the number of DDvibs becomes below N.

Based on policy No. 4, for example, if the number of DSvibs (HDDs 1-A) in a certain time becomes M or more, the controller PC 2 halts the operation of a part of or all DDvibs (HDDs 1-B) at the certain time such that the number of HDDs 1-B which are expected to operate in the certain time becomes below N.

The corresponding information indicative of which process is to generate oscillation or which process is to be influenced by oscillation is preliminarily known, and the information may be optionally set by a user in the HDD 1 or the controller PC 2 in advance. If the information is shared by the HDD 1 and the controller PC 2 via a loaded program, or is only known by the controller PC 2, for example, a step number assigned to the process (for example No. 1 of FIG. 4(b)) is exchanged between the HDD 1 and the controller PC 2, the controller PC 2 can determine whether or not the process currently executed by the HDD 1 is to generate oscillation or is to be influenced by oscillation. In that case, the information indicative of an operation to generate oscillation or an operation to be influenced by oscillation may be, for example, associated with step numbers assigned to the processes to be stored in the HDD 1 and the controller PC 2.

Furthermore, for example, if the HDD 1 alone knows which process is an operation to generate oscillation and which process is an operation to be influenced by oscillation, information of out_vib which is indicative of the treatment to generate oscillation may be included in the message as in No. 2 of FIG. 4 (b), and the information indicating that the process load_unload is to generate oscillation can be shared with the controller PC 2. Similarly, as in the message of No. 3 of FIG. 4(b) including information of req_silence which is indicative of the treatment to be influenced by oscillation, the information indicating that the process initial_pattern_write is to be influenced by oscillation can be shared with the controller PC 2.

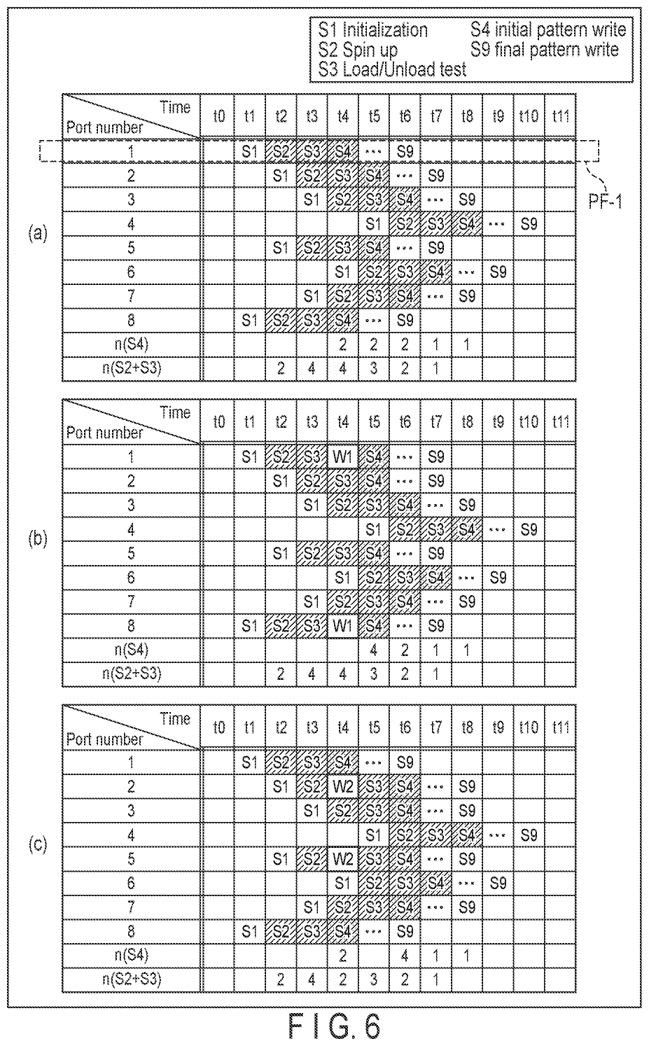

FIG. 6 illustrates an example of operation schedule of the magnetic disk device determined by the controller PC of the embodiment.

As in FIG. 6, by requesting a halt of the process executed by the HDD 1 to a part of the HDDs 1, the process which is influenced by oscillation can be performed by other HDDs 1 under a condition where the influence by external oscillation is reduced. Details will be explained with respect to FIG. 6.

In this example, for the convenience of explanation, the number of ports of the pallet 4 is eight, and an arrangement position of the HDDs 1 in the pallet 4 will not be considered. For example, on this pallet, if four or more HDDs 1 perform the operation which causes oscillation at the same time, the operation of other HDDs 1 which is easily influenced by the oscillation is apparently affected.

In FIG. 6, a column direction indicates time, and a row direction indicates port number N of port 5, where a process (operation state) executed in each port 5-N at each time will be indicated. In this example, n (S) indicates the number of port 5 in which the treatment step S is executed in the corresponding time, that is, the number of HDDs 1.

S1 to S9 are operation conditions (processes to be executed), and for example, S1 is initialization treatment, S2 is Spin up treatment, S3 is Load/Unload test treatment, S4 is Initial pattern write treatment, and S9 is Final pattern write treatment. Basically, in each HDD 1, treatments S1 to S9 are executed sequentially. Furthermore, W1 and W2 are operation conditions indicate a halt of the treatment. Note that, in the present embodiment, nine treatment steps are used for example, however, the contents and the number of such treatment steps will differ based on the contents of the manufacturing process, and the present embodiment can be applied to such different cases.

For example, treatment flow PF-1 of FIG. 6(a) indicates an example of a flow of the treatment step executed by HDD 1-1 of port 5-1, execution of treatment S1 starts at time t1, and executions of treatments S2, S3, S4, and S9 start at times t2, t3, t4, and t6, respectively. Treatments from t4 to t6 are omitted, and therein, treatments S5 to S8 may be executed, for example. Note that, for the convenience of explanation, t0 to t11 and treatments S1 to S9 are set in the same intervals whereas the intervals may differ, and there may be slight differences in the start times of the processes and times required for the processes in the actual port 5, and optional values are applied thereto. Furthermore, such differences occur based on the types of the processes, and differences occur even in the same process in each drive (HDD 1).

The start of the process in each port 5 is not simultaneously, and in FIG. 6(a), treatment S1 which is an initial initialization step is started in ports 5-1 and 5-8 at time t1, then, the operation is started in ports 5-2 and 5-5 at time t2. At time t2, advancing ports 5-1 and 5-8 progress to step S2. The HDD 1 of each port 5 executes treatments S1 to S9 sequentially and then, ends the manufacturing process.

Here, treatments S2 and S3 being hatched in the figure are examples of operation which generates oscillation, and for example, treatment S2 is a start test of the spindle motor 12 and treatment S3 is a head load/unload test. In this example, treatments S2 and S3 which generate oscillation are executed at four HDDs 1 (ports 5-1, 5-2, 5-5, and 5-8) at times t3 to t4 at the same time, that is, n (S2+S3)=4. Note that, treatment S4 which is to be influenced by oscillation will be executed by two HDDs 1 (ports 5-1 and 5-8) at time t4, that is, n(S4)=2.

Here, when the treatment S2 or S3 which causes oscillation is executed in the four or more HDDs 1 at the same time, the treatment S4 which is influenced by the oscillation is apparently affected, and thus, an adjustment to avoid the execution of S4 at time t4 in this condition is performed.

FIG. 6(b) illustrates an example where the controller PC 2 adjusts an operation schedule such that the HDD 1 to halt the treatment which is influenced by oscillation, and illustrates the following condition.

When the controller PC 2 requests a halt w1 with respect to two HDDs 1 (ports 5-1 and 5-8) which are to execute the treatment S4 at time t4, only the ports to perform the treatments S2 and S3 at time t4 are operated as a result of the request, and at time t5, only three HDDs 1 (ports 5-3, 5-6, and 5-7) perform the treatment which causes oscillation, and thus, because less than four HDDs performing such a treatment, the treatment S4 which is influenced by oscillation will not be influenced by oscillation. Furthermore, a halt continues for a designated time period, and the HDDs 1 requested for a halt resume their treatments after the designated time period, and thus, there is no hang-up or deadlock regardless of conditions.

FIG. 6(c) illustrates an example where the controller PC 2 requests a halt with respect to the HDD 1 which is to execute a treatment which cause oscillation, and illustrates the following condition.

As with the case of FIG. 6(a), in the pallet 4 starting the operation, the controller PC 2 requests a halt w2 with respect to two HDDs 1 (ports 5-2 and 5-5) which are to execute the treatment S3 at time t4. As a result of the request, the number of ports to execute the treatments S2 and S3 at time t4 is two (ports 5-3 and 5-7), and because less than four HDDs perform the treatments S2 and S3, the treatment S4 by another HDD 1 is not influenced by oscillation. Therefore, after time t4, the treatments S2 and S3 are not executed by four or more HDDs when the treatment S4 is executed by another HDD 1. The example of FIG. 6(c) corresponds to a case where N=4 in the No. 2 policy of FIG. 5, and the value N may be an optional natural number.

Note that, the operation time of each treatment by the HDD 1 in actuality varies, and the end time of actual treatment step may not be exact to the estimated time, and thus, the controller PC 2 side arbitrarily outputs a message request (for example, message of No. 1 in FIG. 4(a)) with respect to all ports 5 (and HDDs 1) after t4 in order to grasp the operation mode of the ports, and performs additional schedule adjustment if necessary.

Through the above-described method, the operation of the process which is influenced by oscillation of a certain HDD 1 is not influenced by oscillation from a process which causes oscillation, and thus, a decrease in defective rate and an improvement in quality of the magnetic disk device 1 can be expected.

In the following, the treatment operation of the present embodiment will be explained.

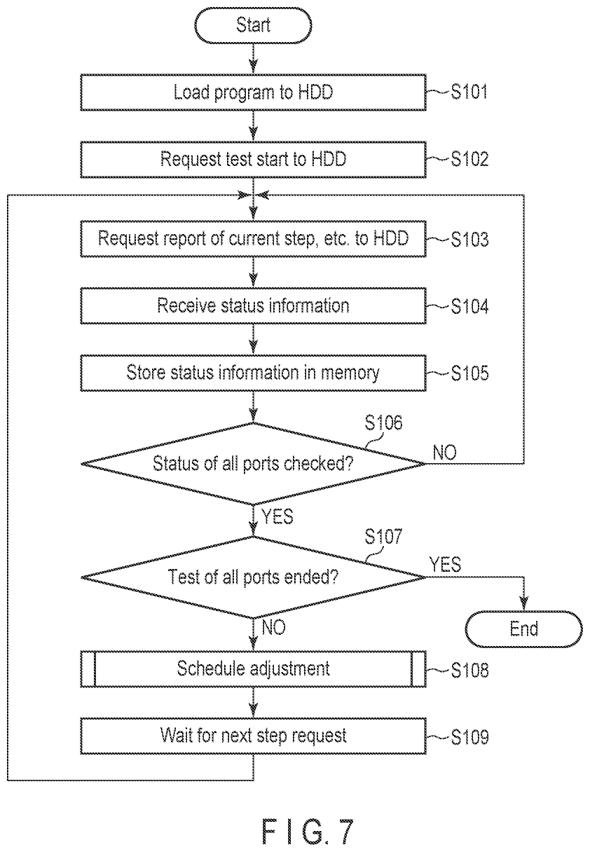

FIG. 7 is a flowchart indicative of a test treatment of HDD by the controller PC of the embodiment.

Initially, the controller PC 2 sequentially loads a program in one or more HDDs 1 (step S101), and issues a test start request (step S102). Each HDD 1 internally performs operations from the initialization treatment of treatment S1, and when the operation reaches treatment S9, the test ends. The controller PC 2 outputs a message (for example, message of No. 1 of FIG. 4(a)) at suitable intervals, in order to request each port 5 to report current treatment step of HDD 1, and treatment step end time, for example (step S103), and the received result is stored in a nonvolatile memory 24 on the controller PC 2, for example (steps S104 and S105).

The controller PC 2 acknowledges the status of all ports 5 (Yes in step S106), and if the test of all ports 5 is finished, ends the treatment (Yes in step S107). On the other hand, if there is a port 5 executing a test step (No in step S107), the schedule adjustment part 211 determines whether or not a schedule adjustment is necessary (step S108). Note that, if two or more HDDs 1 are executing the test step in step S107, then the schedule adjustment part 211 may determine the necessity for a schedule adjustment in step S108.

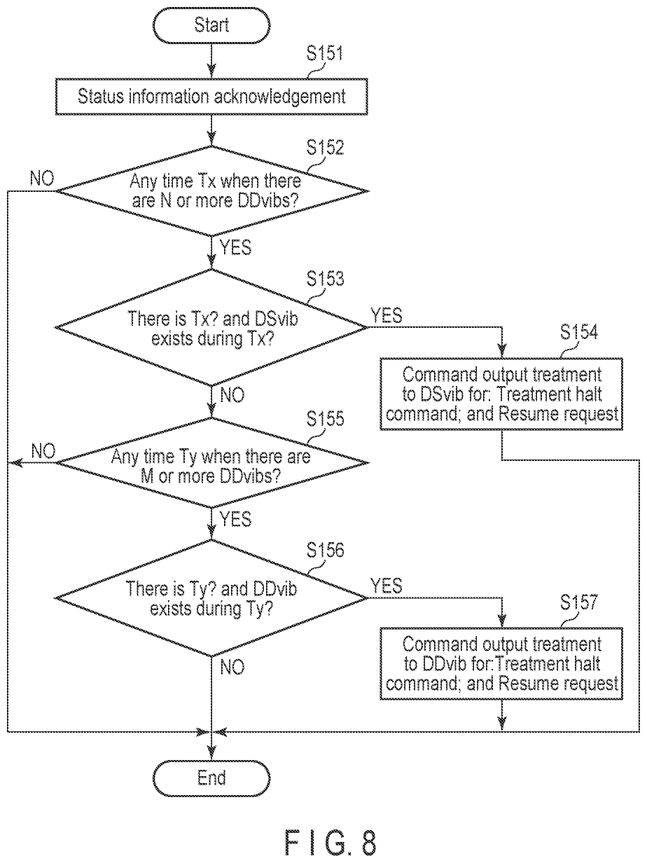

FIG. 8 is a flowchart indicating an operation schedule adjustment treatment of the HDD by the controller PC of the embodiment, which corresponds to step S108 of FIG. 7, wherein policies No. 1 to No. 4 of FIG. 5 are achieved by a program, for example.

The controller PC 2 acknowledges already-acquired status information per port 5 (step S151), and based on the status information, searches a time band Tx where the number of HDDs 1 which become DDvib in the next treatment step becomes N or more (N is natural number) (step S152). If there is Tx (Yes in step S152) and there is DSvib during Tx (Yes in step S153), a treatment temporal halt command with respect to a part of or all HDDs 1 which are to be DSvib in order to request a halt of the treatment (step S154).

Upon receipt of the treatment temporal halt command, the HDD 1 halts the treatment until a designated time without transitioning to the next step after the currently-executed step ends. Furthermore, in step S154, the controller PC 2 calculates a treatment end estimated time of DDvib from the status information of each port 5, and outputs a resume request to resume the halted treatment including a time to cancel the halt with respect to the DSvib.

Furthermore, if the condition is not satisfied in step S153 (No in step S155), the controller PC 2 searches a time Ty when the number of the HDDs 1 which become DSvib in the next treatment step becomes M or more (M is natural number) (step S155). If there is Ty and there is DDvib during Ty (Yes in step S156), the controller PC 2 outputs a treatment temporal halt command with respect to a plurality of ports 5 such that the number of DDvibs becomes N or less in order to request a halt of the treatment (step S157). Furthermore, in step S157, the controller PC 2 calculates a treatment end estimated time of DS from the status information of the ports 5, and outputs a resume request to resume the halted treatment including a time to cancel the halt with respect to the DDvib. Upon receipt of the treatment temporal halt command and the resume request, the HDD 1 halts the treatment until the designated time without transitioning to the next step after the currently-executed step ends.

Referring to FIG. 7, in step S108, upon receipt of a message of the treatment temporal halt command and the resume request, the HDD 1 halts the treatment according to the received message. The controller PC 2 waits for a time when the halted HDD 1 executes the next process based on the time calculated step S108, for example (step S109).

Through the aforementioned process, the HDDs 1 operating in the process which is influenced by oscillation can reduce the influence from the process of other HDDs 1 which causes oscillation.

Note that, the flowchart of the present embodiment is merely an example, where step S154 is prioritized than step S157 in FIG. 8, for example. However, step S157 may be prioritized than step S154 instead. Furthermore, steps S154 and S157 are shown in a single flowchart while only one of the steps may be performed instead. That is, by applying optional policies as in FIG. 5 or a combination of such policies, the flowchart can be changed, and is encompassed within the scope of the invention of the present application.

### Second Embodiment

The present embodiment presents, other than the policies of FIG. 5, examples of different policies utilized in a case where physical conditions between different ports 5 (physical position, physical distance, horizontally-aligned ports, and vertically-aligned ports), and physical conditions such as a temperature increase, lowering power voltage, and power source shortage of HDDs 1 are external factors.

A magnetic disk device 1 of the present embodiment may include a temperature measurement part to measure a temperature of the magnetic disk device which is not shown, and a power measurement part to measure a power voltage and a power charge which is not shown. The magnetic disk device 1 may include the physical conditions such as measured temperature, power voltage, and power charge into status information to be reported to the controller PC 2.

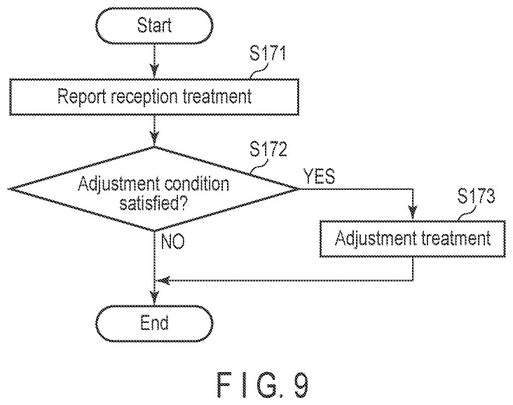

FIG. 9 illustrates a second flowchart indicative of an operation schedule adjustment treatment of the HDD by the controller PC of the embodiment.

Upon receipt of a reply (report) with respect to the output message from each HDD 1 (step S171), the controller PC 2 determines execution, halt, and the like of the process of each HDD 1 based on the received report (step S172), and outputs the determined content with respect to each HDD 1, and adjusts the operation schedule of each HDD 1 (step S173).

Step S172 corresponds to steps S152, S153, S155, and S156 of FIG. 8, and step S173 corresponds to steps S154 and S157 therein. For example, the adjustment condition of step S152 and the adjustment treatment of step S154 are based on the policy of No. 3 of FIG. 5.

The adjustment condition is prepared including physical conditions between different ports 5 (physical position, physical distance, horizontally-aligned ports, and vertically-aligned ports) and physical conditions of the HDD 1 in the process such as a temperature rise, lowered power voltage, and power charge shortage, and operation commands to each HDD 1 with respect to the adjustment conditions are preliminarily determined and reflected upon programs. Thereby, the operation schedule adjustment of each HDD 1 can be performed in the similar treatment as in the flowchart of FIG. 7.

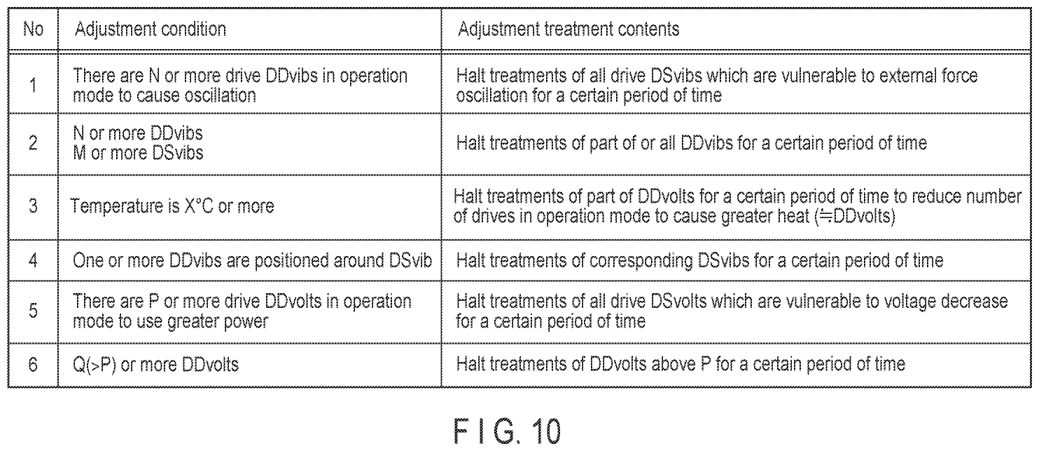

FIG. 10 illustrates an example of data indicative of relationship between the operation schedule adjustment condition and adjustment treatments of the HDD by the controller PC of the embodiment.

Policies No. 1 and No. 2 are examples of the first embodiment in which the adjustment conditions only include conditions related to operation conditions. Policies No. 3, No. 4, No. 5, and No. 6 are examples in which the adjustment conditions include conditions related to both the operation conditions and physical conditions. Drive Sensitive Voltage (DSvolt) indicates a drive HDD 1 which is in an operation mode to be influenced by a varying power voltage, and DDvolt indicates a drive HDD 1 which is in an operation mode which tends to cause a varying power voltage.

Note that, the operation mode which tends to cause a varying power voltage is an operation mode which consumes greater power, and tends to occur in an operation mode which causes oscillation such as load/unload operation and activation of spindle motor.

Furthermore, HDDs 1 which are in an operation mode which is easily influenced including DSvib and DSvolt will be referred to as DS, and HDDs 1 which are in an operation mode which causes oscillation including DDvib and DDvolt will be referred to as DD.

Information of corresponding relationship indicative of which process is an operation which causes oscillation or an operation to be easily influenced by oscillation may be optionally set in an HDD 1 or the controller PC 2 by a user.

For example, if policy No. 3 is applied, the controller PC 2 analyzes the received status information, and if there is an HDD 1 conforming to adjustment condition of temperature X or more (HDD 1-A), outputs a message to execute an adjustment treatment content of halting part of treatment of DDvolt for a certain period of time to decrease the number of drives HDDs 1 in the operation mode generating greater heat to the HDD 1-A. The HDD 1-A halts the process thereof for a certain period of time according to the received message.

For example, if policy No. 4 is applied, the controller PC 2 analyzes the received status information, and if there is an HDD 1 of DSvib conforming to the adjustment condition of being DSvib in the periphery of DDvibs where there are one or more DDvibs (HDD 1-B), outputs a message to execute an adjustment treatment content of halting the treatment of the DSvib for a certain period of time to the HDD 1-B. The HDD 1-B controls the process thereof according to the received message.

As in a case where policy No. 4 is reflected on a program, an adjustment condition of DSvib in the periphery of DDvibs is, for example, defined optionally as DSvib adjacent to DDvib, or DSvib within X (X is a natural number) units from DDvib. This point will be explained further with reference to FIG. 1.

DSvib adjacent to DDvib is, for example, if DDvib HDD 1 of port 5-45 of FIG. 1 (HDD 1-45), an DSvib HDD 1 within four adjacent HDDs 1 (corresponding to HDDs 1-28, 44, 46, and 62).

Furthermore, DSvib within X units (or X rounds) from DDvib is, for example, if port 5-45 of FIG. 1 (HDD 1-45) is DDvib and X=2, DSvib HDDs 1 of 24 HDDs 1 (corresponding to HDDs 1-9, 10, 11, 12, 13, 26, 27, 28, 29, 30, 43, 44, 46, 47, 60, 61, 62, 63, 64, 77, 78, 79, 80, and 81).

Policy No. 5 indicates an adjustment condition and adjustment treatment contents in a case where P or more drive DDvolts in an operation mode which uses greater power are on the pallet 4, for example. Upon detection of a match to the adjustment condition, the controller control part 21 halts the treatment of drive DSvolts which are vulnerable to all voltage decrease for a certain period of time. DSvolt HDDs 1 halt the process thereof for a certain period of time according to the message received from the controller control part 21.

Policy No. 6 indicates an adjustment condition and adjustment treatment content in a case where Q or more DDvolts are on the pallet 4, for example. Upon detection of a match to the adjustment condition, the controller control part 21 halts the treatment of P HDDs 1 (where Q>P) of the DDvolts for a certain period of time. DSvolt HDDs 1 halt the process thereof for a certain period of time according to the message received from the controller control part 21.

The policy can be set freely, and the adjustment condition may be set using physical conditions between multiple HDDs 1 (physical position, physical distance, horizontally-aligned ports, and vertically-aligned ports), optional physical conditions of HDD 1 such as temperature, power voltage, and power charge thereof, operation conditions of HDD 1, and a combination of the above. For example, the number of HDDs 1 executing a process at the same time may be limited by power charge input to the pallet 4.

The aforementioned policies can be set freely to the controller PC 2 by being reflected upon programs, and optional policies can be set.

Through the above procedure, treatment operations of the manufacturing process with respect to each HDD 1 can be scheduled based on optional policies.

Embodiments may be characterized as follows.

(A-1) A magnetic disk manufacturing pallet control method including a mechanism in which a control PC 2 inquires to an HDD 1 in a magnetic disk manufacturing pallet 4 as to a current operation mode, an estimated time until the end of the current operation mode, and a next operation mode, and the HDD 1 responses to the inquiry.

(A-2) The magnetic disk manufacturing pallet control method of (A-1), in which the operation mode of a part or all of the HDDs 1 within the same pallet 4 for magnetic disk manufacturing is grasped by the controller PC 2, and if the controller PC 2 determines that the number of HDDs 1 performing a specific operation become large, the part or all of the HDDs 1 are requested to change execution schedule of the treatment.

(A-3) A magnetic disk manufacturing pallet control method in which the operation mode of a part or all of the HDDs 1 within the same pallet 4 for magnetic disk manufacturing is grasped by the controller PC 2, and if there is one or more HDDs 1 which are to execute a specific operation (HDDs 1-A), and one or more HDDs 1 (other than HDDs 1-A) which are adjacent to the port 5 where the HDDs 1-A exist or are physically close to the port 5 may cause an external force such as oscillation to the operation of the HDDs 1-A, the controller PC 2 sends a message to the HDDs 1-A which are to execute the specific operation, and a part or all of the HDDs 1-A are requested to change execution schedule of the treatment to perform the specific operation after the internal force such as oscillation caused by the HDDs 1 other than HDDs 1-A, adjacent or physically close to the HDDs 1-A.

In the above (A-1) method, the controller PC 2 grasps current operation contents and immediate operation schedule of one or more HDDs 1 within the pallet 4. Thereby, which HDDs in which ports should be schedule-adjusted can be calculated in order to optimize the operation schedule of the whole HDDs in the pallet.

In the above (A-2) method, the execution schedule change is requested with respect to the HDD 1 in a specific port 5, and the HDD 1 requested for the schedule change can avoid operating in a time band when it will be influenced by a specific operation which possibly cause an external force in the pallet 4.

In the above (A-3) method, the operation of physically close HDDs 1 which are further influenced by the force is focused, and frequency of the schedule adjustment delaying the treatment can be minimized, and increase of process time can be minimized.

According to the aforementioned embodiments, a manufacturing process control method with respect to a plurality of magnetic disk devices can be presented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Processing steps in the flowcharts and sequence charts, and the like described in the aforementioned embodiments are within the scope of the invention even if steps are exchanged, deleted, or added without departing from the spirit and scope of the invention.

Processings indicated in the flowcharts, sequence charts, and the like may be realized by hardware such as CPU, IC chip, digital signal processor (Digital Signal Processor: DSP), software operable in a computer including a microcomputer (program, for example), or a combination of hardware and software.

Furthermore, claims written as a processing logic, as a program including instructions executing in a computer, or as a computer-readable recording medium with the instruction are encompassed within the scope of the invention. Furthermore, terms used in the above are not limited, and other expressions which are understandable as substantially the same are encompassed within the scope of the invention.

What is claimed is:

1. A production pallet control system, comprising:
a plurality of magnetic disk devices configured to execute a plurality of processes, and the magnetic disk devices configured to output status information related to the process based on a requires from the outside; and
a controller connected to the magnetic disk devices in a mutually communicable manner, the controller configured to inquire the status information of each of the magnetic disk devices.

2. The production pallet control system of claim 1,
wherein a process of at least one magnetic disk device is controlled based on an operation mode of the magnetic disk devices confirmed from the status information received from the magnetic disk devices.

3. The production pallet control system of claim 2,
wherein an adjustment condition including a condition with respect to the operation mode and a control content with respect to the process are associated with each other in advance.

4. The production pallet control system of claim 2,
wherein a first magnetic disk device (DV) configured to execute a process of the processes which influences another magnetic disk device, and a second magnetic disk device (DS) configured to execute a process of the processes which is influenced by another magnetic disk device are distinguished.

5. The production pallet control system of claim 4,
wherein a process of at least one magnetic disk device of the magnetic disk devices is controlled based on at least the number of the first magnetic disk device (DD).

6. The production pallet control system of claim 4,
wherein a process of at least one magnetic disk device of the magnetic disk devices is controlled based on at least the number of the second magnetic disk device (DS).

7. The production pallet control system of claim 5,
wherein the process of the first magnetic disk device (DD) is controlled.

8. The production pallet control system of claim 6,
wherein the process of the first magnetic disk device (DD) is controlled.

9. The production pallet control system of claim 5,
wherein the process of the second magnetic disk device (DS) is controlled.

10. The production pallet control system of claim 6,
wherein the process of the second magnetic disk device (DS) is controlled.

11. The production pallet control system of claim 3,
wherein the adjustment condition includes at least one of a temperature and a power consumption value of the magnetic disk device, and a positional relationship between the magnetic disk devices.

12. A production pallet control method, comprising:
inquiring status information of a process of a plurality of magnetic disk devices; and
acquiring the status information of the magnetic disk devices.
